(19) United States
(12) Patent Application Publication
(10) Pub. No.: US 2005/0278933 A1
(43) Pub. Date: Dec. 22, 2005

(54) Joint Design For Large SLS Details

(75) Inventors: John G. Macke JR., St. Louis, MO (US); Jack G. Buchheit, St. Charles, MO (US); Nancy Samson, St. Charles, MO (US)

Correspondence Address: ARTZ & ARTZ, P.C., 28333 TELEGRAPH RD., SUITE 250, SOUTHFIELD, MI, 48034, US

(73) Assignee: THE BOEING COMPANY, Chicago, IL (US)

(21) Appl. No.: 10/710,152

(22) Filed: Jun. 22, 2004

(51) Int. Cl. B29C 35/08; B29C 41/02

(52) U.S. Cl. 29/525.02; 264/497

(57) ABSTRACT

A system for manufacturing a tool within a laser sintering system includes a chamber enclosing a sinter material. The laser sintering system grows or sinters the tool from the sinter material in response to signals from a controller, which generates the signals as a function of a predetermined tool design. The predetermined tool design includes several sections that are grown separately and are later coupled together.

### FEDERAL RESEARCH STATEMENT

[Federal Research Statement Paragraph]This invention was made with government support on contract N00019-01-C-0012. The Government has certain rights in this invention.

### BACKGROUND OF INVENTION

The present invention relates generally to tooling systems and processes and is more specifically related to the fabrication of tools through selective laser sintering.

Traditional fabrication methods for tools having areas of contour have included fiberglass lay-ups on numerically controlled machined master models or facility details.

A manufacturing master model tool, or “master model”, is a three-dimensional representation of a part or assembly. The master model controls physical features and shapes during the manufacture or “build” of assembly tools, thereby ensuring that parts and assemblies created using the master model fit together.

Traditional tool fabrication methods rely on a physical master model. These master models may be made from many different materials including: steel, aluminum, plaster, clay, and composites; and the selection of a specific material has been application dependent. Master models are usually hand-made and require skilled craftsmen to accurately capture the design intent. Once the master model exists, it may be used to duplicate tools.

The master model becomes the master definition for the contours and edges of a part pattern that the master model represents. The engineering and tool model definitions of those features become reference only.

Root cause analysis of issues within tool families associated with the master has required tool removal from production for tool fabrication coordination with the master. Tools must also be removed from production for master model coordination when repairing or replacing tool details. Further, the master must be stored and maintained for the life of the tool.

Master models are costly in that they require design, modeling and surfacing, programming, machine time, hand work, secondary fabrication operations, and inspection prior to use in tool fabrication.

In summary, although used for years, physical master models have inherent inefficiencies, including: they are costly and difficult to create, use, and maintain; there is a constant risk of damage or loss of the master model; and large master models are difficult and costly to store.

By way of further background, the field of rapid prototyping of parts has, in recent years, made significant improvements in providing high strength, high density parts for use in the design and pilot production of many useful objects. “Rapid prototyping” generally refers to the manufacture of objects directly from computer-aided-design (CAD) databases in an automated fashion, rather than from conventional machining of prototype objects following engineering drawings. As a result, time required to produce prototype parts from engineering designs has been reduced from several weeks to a matter of a few hours.

An example of a rapid prototyping technology is the selective laser sintering process (SLS) in which objects are fabricated from a laser-fusible powder. According to this process, a thin layer of powder is dispensed and then fused, melted, or sintered, by a laser beam directed to those portions of the powder corresponding to a cross-section of the object.

Conventional selective laser sintering systems position the laser beam by way of galvanometer-driven mirrors that deflect the laser beam. The deflection of the laser beam is controlled, in combination with modulation of the laser itself, for directing laser energy to those locations of the fusible powder layer corresponding to the cross-section of the object to be formed in that layer. The laser may be scanned across the powder in a raster fashion or a vector fashion.

In a number of applications, cross-sections of objects are formed in a powder layer by fusing powder along the outline of the cross-section in vector fashion either before or after a raster scan that fills the area within the vector-drawn outline. After the selective fusing of powder in a given layer, an additional layer of powder is then dispensed and the process repeated, with fused portions of later layers fusing to fused portions of previous layers (as appropriate for the object), until the object is completed.

Selective laser sintering has enabled the direct manufacture of three-dimensional objects of high resolution and dimensional accuracy from a variety of materials including polystyrene, NYLON, other plastics, and composite materials, such as polymer coated metals and ceramics. In addition, selective laser sintering may be used for the direct fabrication of molds from a CAD database representation of the object in the fabricated molds. Selective Laser Sintering has, however, not been generally available for tool manufacture because of SLS part size limitations, lack if robustness of SLS objects, and inherent limitations in the SLS process.

The disadvantages associated with current tool manufacturing systems have made it apparent that a new and improved tooling system is needed. The new tooling system should reduce need for master models and should reduce time requirements and costs associated with tool manufacture. The new system should also apply SLS technology to tooling applications. The present invention is directed to these ends.

### SUMMARY OF INVENTION

In accordance with one aspect of the present invention, a system for manufacturing a tool within a laser sintering system includes a chamber enclosing a sinter material. The laser sintering system grows or sinters the tool from the sinter material in response to signals from a controller, which generates the signals as a function of a predetermined tool design. The predetermined tool design includes several sections that are grown separately and later coupled together.

In accordance with another aspect of the present invention, a method for laser sintering a tool includes predetermining a number of sections for the tool and predetermining locations of joint features on the sections. The sections are then sintered individually and connected.

One advantage of the present invention is that use of Selective Laser Sintering can significantly reduce costs and cycle time associated with the tool fabrication process. An additional advantage is that tool features can be “grown” as represented by the three-dimensional computer model, thus eliminating the requirement for a master model or facility detail. The subsequent maintenance or storage of the master/facility is thereby also eliminated.

Still another advantage of the present invention is that the model remains the master definition of the tool, therefore root cause analysis or detail replacement may be done directly from the model definition. Secondary fabrication operations are further eliminated where features are “grown” per the three-dimensional solid model definition.

A further advantage is that tools larger than may be sintered by the sinter system may be sintered as individual sections and later coupled together, thereby increasing versatility of sinter systems.

Additional advantages and features of the present invention will become apparent from the description that follows, and may be realized by means of the instrumentalities and combinations particularly pointed out in the appended claims, taken in conjunction with the accompanying drawings.

### BRIEF DESCRIPTION OF DRAWINGS

In order that the invention may be well understood, there will now be described some embodiments thereof, given by way of example, reference being made to the accompanying drawings, in which:

FIG. 1 illustrates a sintering system in accordance with one embodiment of the present invention;

FIG. 2 illustrates a perspective view of a tool, fabricated in the system of FIG. 1, in accordance with another embodiment of the present invention;

FIG. 3 illustrates an enlarged partial view of FIG. 2;

FIG. 4 illustrates an exploded view of a combination of sections of the tool of FIG. 2 in accordance with another embodiment of the present invention;

FIG. 5 illustrates an assembled view of FIG. 4; and

FIG. 6 illustrates a logic flow diagram of a method for operating a sintering system in accordance with another embodiment of the present invention.

### DETAILED DESCRIPTION

The present invention is illustrated with respect to a sintering system particularly suited to the aerospace field. The present invention is, however, applicable to various other uses that may require tooling or parts manufacture, as will be understood by one skilled in the art.

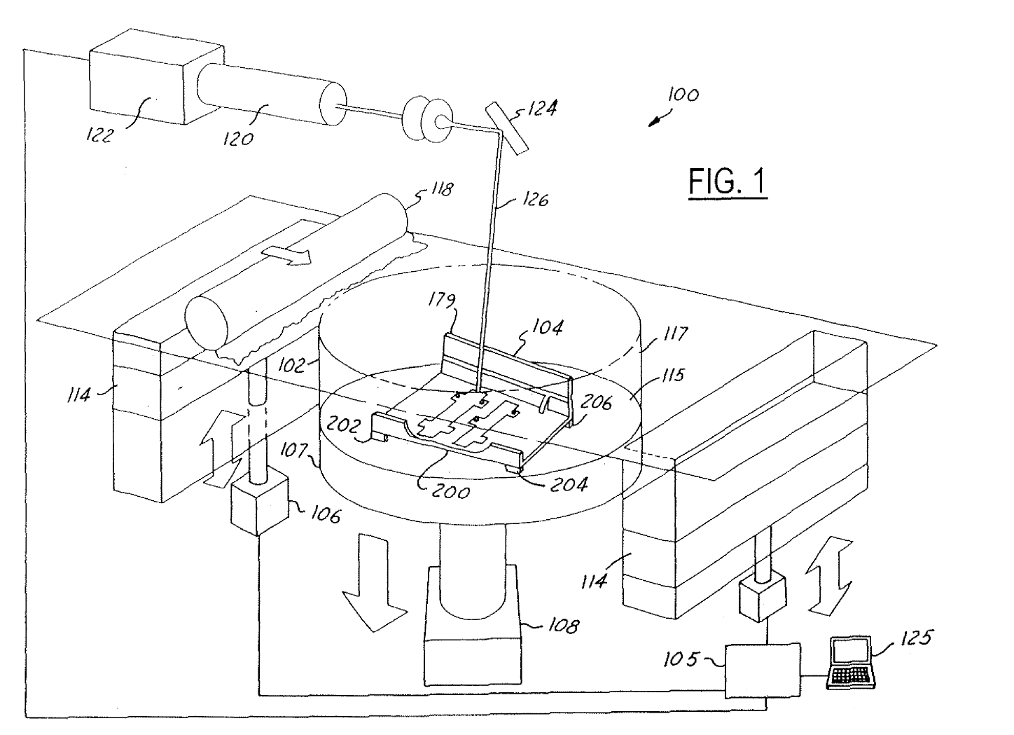

FIG. 1 illustrates a selective laser sintering system 100 having a chamber 102 (the front doors and top of chamber 102 not shown in FIG. 1, for purposes of clarity). The chamber 102 maintains the appropriate temperature and atmospheric composition (typically an inert atmosphere such as nitrogen) for the fabrication of a tool section 104. The system 100 typically operates in response to signals from a controller 105 controlling, for example, motors 106 and 108, pistons 114 and 107, roller 118, laser 120, and mirrors 124, all of which are discussed below. The controller 105 is typically controlled by a computer 125 or processor running, for example, a computer-aided design program (CAD) defining a cross-section of the tool section 102.

The system 100 is further adjusted and controlled through various control features, such as the addition of heat sinks 126, optimal objection orientations, and feature placements, which are detailed herein.

The chamber 102 encloses a powder sinter material that is delivered therein through a powder delivery system. The powder delivery system in system 100 includes feed piston 114, controlled by motor 106, moving upwardly and lifting a volume of powder into the chamber 102. Two powder feed and collection pistons 114 may be provided on either side of part piston 107, for purposes of efficient and flexible powder delivery. Part piston 107 is controlled by motor 108 for moving downwardly below the floor of chamber 102 (part cylinder or part chamber) by small amounts, for example 0.125 mm, thereby defining the thickness of each layer of powder undergoing processing.

The roller 118 is a counter-rotating roller that translates powder from feed piston 114 to target surface 115. Target surface 115, for purposes of the description herein, refers to the top surface of heat-fusible powder (including portions previously sintered, if present) disposed above part piston 107; the sintered and unsintered powder disposed on part piston 107 and enclosed by the chamber 102 will be referred to herein as the part bed 117. Another known powder delivery system feeds powder from above part piston 107, in front of a delivery apparatus such as a roller or scraper.

In the selective laser sintering system 100 of FIG. 1, a laser beam is generated by the laser 120, and aimed at target surface 115 by way of a scanning system 122, generally including galvanometer-driven mirrors 124 deflecting the laser beam 126. The deflection of the laser beam 126 is controlled, in combination with modulation of laser 120, for directing laser energy to those locations of the fusible powder layer corresponding to the cross-section of the tool section 104 formed in that layer. The scanning system 122 may scan the laser beam across the powder in a raster-scan or vector-scan fashion. Alternately, cross-sections of tool sections 104 are also formed in a powder layer by scanning the laser beam 126 in a vector fashion along the outline of the cross-section in combination with a raster scan that “fills” the area within the vector-drawn outline.

Referring to FIGS. 1, 2, and 3, a sample tool 150 formed through the SLS system 100 is illustrated. The tool 150 includes a plurality of large sections (first 152, second, third 154, fourth 155, fifth 156, and sixth 157). The sections 152 (alternate embodiment of 104 in FIG. 1), 154, 156 may be sintered simultaneously or consecutively.

During the sintering process, various features are molded into the large tool section or sections. Such features include steps and thickness variations 158, gussets 160, stiffeners 162, interfaces and coordination features for making interfaces 164, construction ball interfaces and coordination holes 170, trim of pocket and drill inserts 166, hole patterns 172, and holes 168 included in multiple details for interfacing hardware, such as detail 180. Important to note is that a first plurality of features, including a combination of the aforementioned features, may be sintered into the first section 152 and a second plurality of features, including a combination of the aforementioned features, may be sintered into the second section 154.

Individually contoured details, such as detail 180, which may also be considered sections of the tool for the purposes of the present invention, may be sintered separately from the main body of the tool 150, such that they may be easily replaced or replaceable or easily redesigned and incorporated in the tool 150. Alternate embodiments include a plurality of individual contoured details, such as 180, 182, 184, and 186. Each of the contoured details includes holes, e.g. 168, such that a bolt 190 may bolt the detail 180 to a section 152, 154, or 156 of the tool 150.

The features, such as the gusset 160 and the stiffener 162 are, in one embodiment of the present invention, grown on the same side of the SLS tool 150. Growing (i.e. sintering) these features on the same side of the tool takes advantage of the sintering process because a feature grown at the beginning of a sintering operation has different properties than the same feature would when grown at the end of a sintering operation. Therefore, the first side 200 undergoing sintering includes all the tool features.

Alternate embodiments of the present invention include various tool features grown on either side of the tool 150 through various other methods developed in accordance with the present invention. One such method includes adding a heat sink 202, or a plurality of heat sinks 202, 204, 206 to various portions of the bed 117 such that different tool features may be cooled subsequent to sintering on the first section 152 or second section 154, thereby avoiding warping that is otherwise inherent in the sintering process. Alternately, a single large heat sink may be placed on one side such that all features cool at the same rate and immediately following the sintering operation.

A further aspect of the present invention includes separating contoured details and various tool aspects by a proximate amount such that warping between the features is limited and structural integrity of the features is maximized.

An alternate embodiment of the present invention includes designing in access features or buffer features 179 in areas where warping will occur during sintering such that these features may be removed when the sintering process is concluded. These buffer features 179 may be predetermined such that connection between them and the main body of the part facilitates detachment through a twisting off or breaking off procedure for the buffer feature 179.

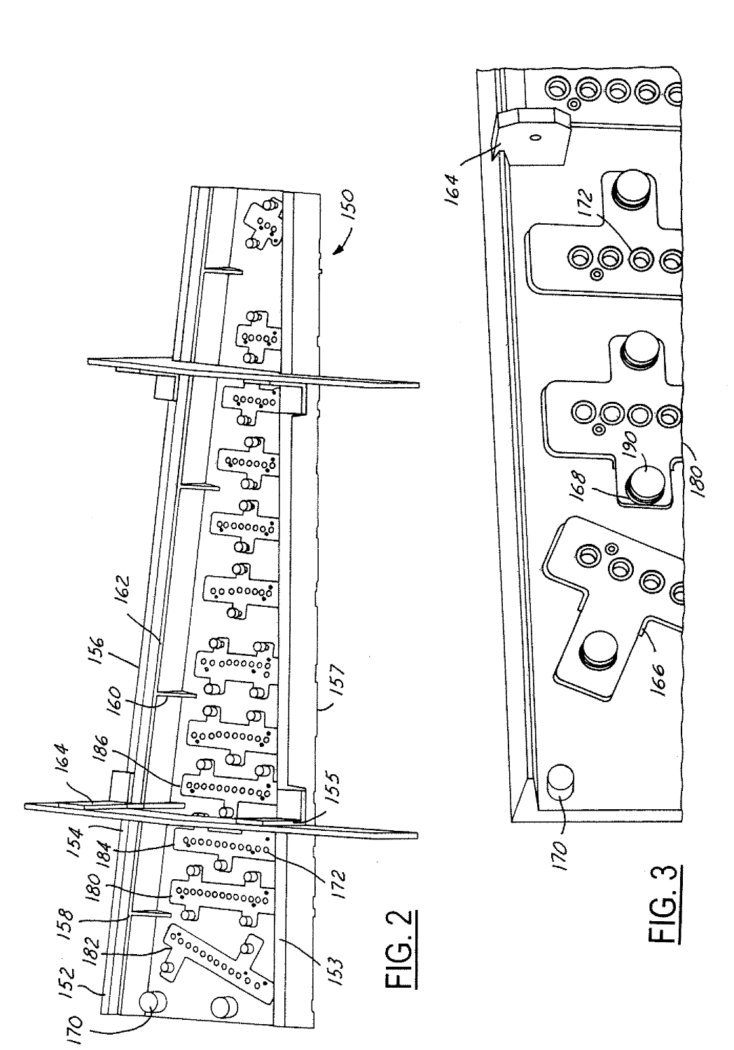

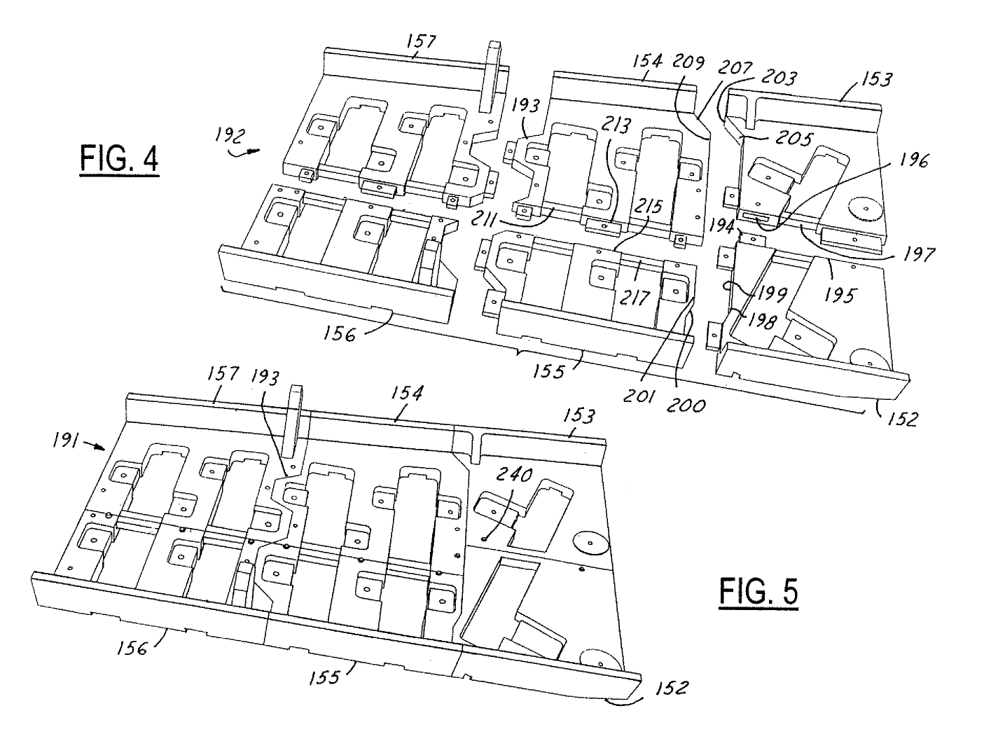

Referring to FIGS. 4 and 5, an exploded view 192 and an assembled view 191 of a combination of sections of the tool system 150 of FIG. 2, in accordance with another embodiment of the present invention, is illustrated. The tool 150 includes a plurality of large sections (e.g. first 152, second 153, third 154, fourth 155, fifth 156, and sixth 157). Important to note is that the tool 150 may include any number of sections that fit together to form numerous types of tools.

In accordance with one embodiment of the present invention, each of the tool sections include at least one tongue 194 or tapered tongue feature and groove feature 196 such that the sections may be fit easily together. For example, the first section 152 includes a first tongue feature 194 on a first mating edge 195, and the second section 153 includes a first groove feature 196 on a first mating edge 197 for receiving the tongue feature 194. Further, the first section 152 may include a groove feature 198 (second groove feature) on a second mating edge 199 for receiving a second tongue feature 200 on a mating edge 201 of the fourth section 155. Important to not is that the second section 153 also includes a second mating edge 203 including a joint component or feature 205, whereby this joint feature 205 may couple to a joint feature 207 on a first mating edge 209 of the third section 154. The third section 154 may include a second mating edge 211 including at least one joint feature 213 for coupling to a joint feature 215 on a second mating edge 217 of the fourth section 155.

Including a joint, such as a groove and a tongue, on each connective section of the tool 150 increases strength of the tool 150, as the grooves and tongues reduce potential effects of torque applied to various sections. Important to note is that the various sections may include one or more joints on one or more sides or edges depending on the size and shape of the tool.

The tapered tongue and groove features are grown on/into the mating edges of adjacent sections for forming a high strength joint. In one embodiment of the present invention, a cross pin 240 or a plurality of cross pins 240 are used through the tongue 194 and the walls of the groove 196 for accurately aligning the adjacent pieces, thus establishing a feature-to-feature relationships across joints.

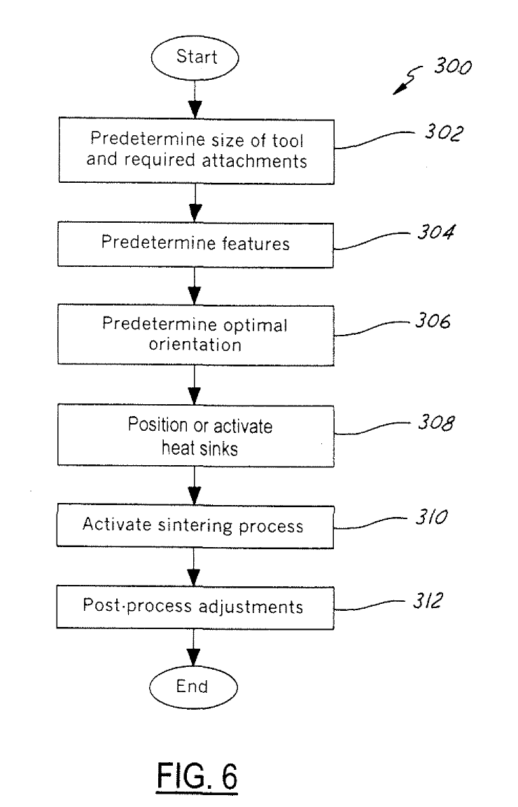

Referring to FIG. 6 logic flow diagram 300 of the method for operating a SLS system is illustrated. Logic starts in operation block 302 where the size of the tool needed is predetermined and attachments required to generate that size of tool are also predetermined. In other words, if the tool requires several sections due to the limitations of the part cylinder 102, the tool is manufactured in a plurality of parts that are joined together through predetermined connectors (joints) that are sintered into the sections within the parts cylinder 102. For the present invention, a large tooling detail is 3-D solid modeled. The large tool is segmented into smaller pieces that are within the size limits of the available SLS chambers.

In operation block 304, the features, such as thickness variations 158, gussets 160, stiffeners 162, interfaces and coordination features 164, construction ball interface and coordination holes 170, trim of pockets and drill inserts 166 and holes 168 provided in details for interface hardware, such as screws, are all predetermined for the tool.

In operation block 306, optimal orientation of the SLS tool design within the parts cylinder is predetermined. In one embodiment of the present invention, this predetermination involves including all features of the tool 150 on the same side of the tool, thereby limiting warping on tool features in accordance with the present invention.

In operation block 308 heat sinks, such as 202, 204, or 206, are positioned in various parts of the parts cylinder 102 such that tool features may be cooled immediately following the sintering process and while the rest of the tool or tool components are being sintered, thereby minimizing warping of the tool features. Alternate embodiments include activating the heat sinks 202, 204, 206 or alternately inputting them into the parts cylinder 102 prior to sintering. Further alternate embodiments include a single heat sink, or a heat sink activating in various regions corresponding to tool features on the tool being sintered.

In operation block 310 the sintering process is activated, and the controller 105 activates the pistons 114, 117, the roller 118, the laser 120, and the mirrors 124. The pistons force sinter material upwards or in a direction of the powder leveling roller 118, which rolls the sinter powder such that it is evenly distributed as a top layer on the parts cylinder 102. The laser 120 is activated and a beam 126 is directed towards scanning gears, which may be controlled as a function of predetermined requirements made in operation block 302. During the sintering operations, the heat sinks 202, 204, 206 are activated for cooling various sintered portions of the tool 150 as they are sintered, and as other parts of the tool are being sintered such that warping is minimized. In alternate embodiments wherein a plurality of tool sections, such as a first and second tool section, are sintered collectively or successively, heat sinks may be included to cool various features of the second tool section as well.

In operation block 312, post-sintering process adjustments are conducted. These adjustments include removing warped portions that were deliberately warped such that tool features would not undergo typical warping associated with the sintering process. Further, post-process adjustments involve fitting together components or sections of the tool 150.

In operation, a method for laser sintering a tool includes predetermining a position for a first tool feature on a first section of the tool; predetermining an orientation of the first section of the tool within the part chamber as a function of minimizing warping of the first tool feature during sintering; activating a heat sink within a part chamber for limiting warping of the first tool feature; laser sintering the first section of the tool within the part chamber; predetermining a position for a second tool feature on a second section of the tool; predetermining an orientation of the second section of the tool within the part chamber as a function of minimizing warping of the second tool feature during sintering; laser sintering the second section of the tool; and coupling the second section to the first section.

From the foregoing, it can be seen that there has been brought to the art a new and improved tooling system and method. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

1. A sintering system comprising:
a tool chamber enclosing a sinter material;
a laser system sintering said sinter material as a function of controller signals; and
a controller generating said controller signals as a function of a predetermined tool design, said predetermined tool design comprising a first section of said tool comprising a joint component for coupling said first section to at least one other section of said tool.

2. The system of claim 1, wherein said predetermined tool design further comprises a second section of said tool, sintered separately from said first section, receiving said joint component of said first section in a second section receiving area.

3. The system of claim 2, wherein said predetermined tool design further comprises a plurality of joint components and receiving areas distributed on both said first section and said second section for coupling together sections of said tool.

4. The system of claim 3, wherein said first section and said second section define holes aligned during an assembly process of said tool, wherein said first section and said second section holes receive at least one bolt bolting said first section to said second section.

5. The system of claim 1, wherein said predetermined tool design further comprises a plurality of sections of said tool, sintered separately from said first section, at least one of said plurality of sections receiving said joint component of said first section in a receiving area, said plurality of sections fitting together in a predetermined manner.

6. The system of claim 1, wherein said joint component comprises a tongue feature or a tongue feature comprising a cross pin for aligning said tongue feature with a second section receiving area.

7. The system of claim 1 further comprising a first heat sink positioned within said tool chamber for cooling said joint component or a second predetermined feature of said tool, thereby limiting warping of said joint component or said predetermined feature during sintering of said tool.

8. The system of claim 1, wherein said predetermined tool design comprises a buffer feature protecting said joint component or a second predetermined feature of said tool such that said buffer feature is primarily affected by heat generated during sintering in an area of said joint component or a second predetermined feature of said tool.

9. The system of claim 1, wherein individual contoured details of said tool are sintered or manufactured during separate operations as said tool and later coupled to said tool at predefined locations on said tool.

10. The system of claim 1 further comprising a plurality of predetermined features comprising said joint component, wherein all of said plurality of predetermined features are designed on one side of said tool.

11. A method for laser sintering a tool within a part chamber comprising:
predetermining a number of required sections for the tool;
predetermining locations of joint features on said number of sections for connecting said number of sections thereby constructing the tool following sinter operations; and
laser sintering a sinter material to form each of said number of sections of the tool individually.

12. The method of claim 11 further comprising predetermining orientations of said number of sections within the part chamber as a function of minimizing warping said joint features or other tool features during sintering.

13. The method of claim 11 further comprising activating a heat sink within the part chamber for limiting warping of said joint features.

14. The method of claim 11 further comprising activating a plurality of heat sinks at predetermined times within the part chamber for limiting warping of tool features comprising said joint features.

15. The method of claim 14 further comprising predetermining an orientation of each of said number of sections of the tool within the part chamber as functions of minimizing warping of said tool features such that all of said tool features are on one side of each section of the tool.

16. The method of claim 11 further comprising predetermining a location of a buffer feature in a close proximity to at least one of said joint features; and removing said buffer feature from the tool following sintering of at least one of said number of sections.

17. The method of claim 11 further comprising predetermining positions on at least one of said number of sections for at least one of a step and thickness variation, a gusset, a stiffener, an interface and coordination feature for making interfaces, a construction ball interface, a coordination hole, a trim of pocket and drill insert, a hole pattern, or a hole for interfacing hardware.

18. A sintering system comprising:
a part cylinder enclosing a sinter powder;
a first heat sink arrangement positioned within said tool chamber for cooling at least one of a first plurality of predetermined features of a tool on a first tool section, thereby limiting warping of said at least one of said first plurality of predetermined features during sintering of said first tool section;
a second heat sink arrangement positioned within said tool chamber for cooling at least one of a second plurality of predetermined features of a tool on a second tool section, thereby limiting warping of said at least one of said second plurality of predetermined features during sintering of said second tool section, said second tool section adapted to couple to said first tool section;
a laser system sintering said first tool section and said second tool section as a function of controller signals; and
a controller generating said controller signals as a function of a predetermined tool design, predetermined positions of said first plurality of tool features and said second plurality of tool features, and a predetermined orientation of said first section and said second section within said part chamber as a function of minimize warping said tool features during sintering, wherein said predetermined tool design comprises a buffer feature protecting at least one of said first plurality of predetermined features or said second plurality of predetermined features such that said buffer feature is primarily affected by heat generated during sintering in an area of said at least one of said first or second pluralities of predetermined features, wherein said first or second pluralities of predetermined features is designed on one side of said tool.

19. The system of claim 18, wherein said first or second pluralities of predetermined features comprise at least one of a step and thickness variation, a gusset, a stiffener, an interface and coordination feature for making interfaces, a construction ball interface, a coordination hole, a trim of pocket and drill insert, a hole pattern, or a hole for interfacing hardware.

20. The system of claim 18, wherein said buffer feature is removable such that damage is limited to said predetermined feature when said buffer feature is removed due to a weak connective link between said buffer feature and said predetermined feature.

21. The system of claim 18, wherein individual contoured details of said tool are sintered or manufactured during separate operations as said tool and later coupled to said tool.

22. The system of claim 18, wherein said controller generates said controller signals as a function of said predetermined tool design through activating said first heat sink arrangement or said second heat sink arrangement depending on which tool section is required.

23. A method for constructing a tool with a sintering system having a part chamber comprising:
predetermining a position for a first joint feature on a first section of the tool;
predetermining an orientation of said first section of the tool within the part chamber as a function of minimizing warping of said joint feature during sintering;
activating a heat sink within a part chamber for limiting warping of said first joint feature;
laser sintering said first section of the tool within said part chamber;
predetermining a position for a receive feature on a second section of the tool;
laser sintering said second section of the tool; and
coupling said first section to said second section through receiving said joint feature in said receive feature.

24. The method of claim 23, wherein coupling said first section to said second section further comprises bolting said joint feature to said receive feature.

25. The method of claim 23 further comprising predetermining positions of a plurality of tool features on said first section of the tool.

26. The method of claim 25, wherein predetermining positions of a plurality of tool features on said first section of the tool further comprises orienting the tool such that all of said tool features are on one side of the tool.

27. The method of claim 23 further comprising predetermining positions of a plurality of tool features on said second section of the tool.

28. The method of claim 23 further comprising predetermining a plurality of sections of the tool comprising said first section and said second section; sintering each of said plurality of sections of the tool separately; and coupling all of said plurality of sections of the tool together.

29. A tool system comprising:
a first section manufactured through a first sintering process comprising at least two mating edges, each of said edges comprising a joint feature;
a second section manufactured through a second sintering process said second section comprising at least two mating edges, each of said edges comprising a joint feature, at least one of said second section joint features designed for coupling to at least one of said first section joint features;
a third section manufactured through a third sintering process said third section comprising at least two mating edges, each of said edges comprising a joint feature, at least one of said third section joint features designed for coupling to at least one of said second section joint features; and
a fourth section manufactured through a fourth sintering process said fourth section comprising at least two mating edges, each of said edges comprising a joint feature, at least one of said third section joint features designed for coupling to at least one of said first section joint features or said third section joint features.

30. The tool system of claim 29, wherein said first section joint features, said second section joint features, said third section joint features, and said fourth section joint features comprise at least one of a tapered tongue or a groove for receiving said tapered tongue.

31. The tool system of claim 29, wherein at least one of said first section, said second section, said third section, or said fourth section further comprise, sintered thereon, at least one of a step and thickness variation, a gusset, a stiffener, an interface and coordination feature for making interfaces, a construction ball interface, a coordination hole, a trim of pocket and drill insert, a hole pattern, or a hole for interfacing hardware.

32. The tool system of claim 29 further comprising a plurality of additional tool sections coupled together during construction of said tool.

33. The system of claim 29, wherein at least one contoured detail is sintered separately from said first section and said second section and is coupled to at least one of said first section or said second section.

34. A method for sintering a tool comprising:
sintering a first plurality of predetermined tool features in a first tool section;
predetermining an orientation of said first tool section within a part chamber as a function of minimizing warping said first plurality of tool features during sintering;
cooling at least one of said first plurality of predetermined tool features during sintering of said first tool section;
sintering an interchangeable contour detail;
coupling said contour detail to said first tool section;
sintering a second plurality of predetermined tool features in a second tool section;
sintering a third plurality of predetermined tool features in a third tool section;
sintering a fourth plurality of predetermined tool features in a fourth tool section; and
coupling said first, second, third, and fourth sections together.

35. The method of claim 34, wherein coupling said contour detail further comprises coupling said contour detail to said first section through either a sintered bolt or a standard bolt or bolting system.

36. The method of claim 34 further comprising predetermining a location of a buffer feature for at least one of said first plurality of predetermined tool features; and removing said buffer feature from the tool following sintering of the tool.

37. The method of claim 34 further comprising orienting said first section such that all of said plurality of tool features are on one side of the tool.

38. The method of claim 34 further comprising sintering a plurality of contour details; and coupling said plurality of contour details to both said first section and said second section.

39. The method of claim 34 further comprising sintering a plurality of tool sections; and coupling said plurality of tool sections to at least one of said first section, said second section, said third section, or said fourth section.

40. The method of claim 39, wherein sintering said plurality of tool sections further comprises predetermining an orientation for each of said plurality of tool sections as a function of limiting warping of features of said plurality of tool sections.
